(19) United States
(12) Patent Application Publication
(10) Pub. No.: US 2010/0140095 A1
(43) Pub. Date: Jun. 10, 2010

(54) ON-DEMAND INTERMITTENT HIGH PURITY WATER PRODUCTION SYSTEM

(76) Inventors: Jacob Telepciak, Leomister, MA (US); Li-Shiang Liang, Harvard, MA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/610,863

(22) Filed: Nov. 2, 2009

Related U.S. Application Data
(60) Provisional application No. 61/110,125, filed on Oct. 31, 2008.

(51) Int. Cl. C02F 1/469; B01D 61/48; C02F 103/04

(52) U.S. Cl. 204/632; 210/257.1; 210/257.2

(57) ABSTRACT

An on-demand system for intermittent high purity water production which by locating a storage tank for pre-polished water just prior to a final high purity polishing device reduces the potential for stagnant water in the system to reduce or degrade product high purity water quality and reduces the actual degradation of high purity water quality. Pre-polished water is preferably produced by reverse osmosis. Final polished water is produced by continuous electrodeionization.

### CROSS REFERENCE TO RELATED APPLICATION AND PRIORITY CLAIM

This invention claims the benefit under 35 USC §119(e) of copending U.S. Provisional Application No. 61/110,125 filed Oct. 31, 2008 entitled USE AND PLACEMENT OF A STORAGE TANK FOR INSTANT PRODUCTION OF PURIFIED WATER which is hereby incorporated by reference in its entirety.

### FIELD OF THE INVENTION

This invention relates to a high purity water production system, and more particularly, to a system and process for producing high purity water so that the purified water is supplied on-demand to a user while the system is concurrently flushed to remove possible contamination developed during storage or idle time.

### BACKGROUND OF THE INVENTION

High purity water is required for many industrial and laboratory applications. Some of these applications are reviewed in Chapter 13, “Ultrapure Water by Membranes” in “Advanced membranes Technology and Applications.” Norman Li et al eds. John Wiley & Sons, New Jersey. The semiconductor, pharmaceutical and power industries require high purity water, sometimes referred to as ultrapure water. In the semiconductor field, ASTM D-5217-99: Standard Guide for Ultra Pure Water describes six types of electronic grade water. The Requirement for three types are given as examples in the table below.

| Parameter | Type E-1 | Type E-1.1 | Type E-1.2 |
|---|---|---|---|
| Resistivity @ 25° C. | 18.2 | 18.2 | 18.2 |
| TOC (ppb) | 5 | 2 | 1 |
| Dissolved Oxygen | 1 | 1 | 1 |
| (ppb) | | | |
| Ions and Metals | 100 | 100 | 50 |
| (ppt) | | | |

In the pharmaceutical industry, high purity water or compendial water, is water used for final drug usage, or water for injection (WFI). Here RO/CEDI tandems are used as part of the overall process. Typical pharmaceutical requirements are conductivity (at 25° C.) less than 1.3 micro Siemens per cm, and TOC less than 500 ppb.

In the power industry RO/CEDI are used to remove silica and organic impurities as well as common ions. Silica can volatilize in the high pressure boilers and precipitate on the blades in the lower pressure turbines. Organics can decompose to form corrosive CO₂ and organic acids in the steam generating steps. Typical requirements are conductivity (at 25° C.) less than 0.1 micro Siemens per cm, silica less than 5-10 ppb, and TOC less than 100 ppb.

Many industries have their own definition of high purity water. It is evident that water of 10-15 M-ohm per cm at 25° C. and less than 100 ppb TOC are a basic need for high purity water.

The combination of reverse osmosis (RO) and continuous electrodeionization (CEDI) is a preferred combination of process steps in the overall method used to produce ultrapure water. RO is used as a pretreatment for CEDI. CEDI requires a small footprint and can remove up to 99% of weakly ionized silica and boron and thereby reduce the load on process steps downstream of the CEDI.

In the large scale applications discussed above, water is produced continuously and once started and at steady state, there is no further need to flush out impurities that form in the system during disuse. However, in smaller systems, where use is intermittent, water may be stagnant in the system for various lengths of time. Examples are water purification for such uses as feeding autoclaves, glassware washers and environmental chambers. Small scale high purity water systems are used in many life science and analytical laboratories to produce water for small volume testing and general laboratory use. In these applications, water is supplied for a specific use and then the water purification system is shut down until the next demand. In these applications the water remaining in the system may deteriorate by absorbing CO₂, microbial growth, or dissolution of metals or particles from piping, storage tanks, or other process equipment.

In these intermittent use systems, the usual process design is to have pretreatment as needed, followed by RO, followed by a CEDI system and finally a storage or flow buffer tank.

It is well known that RO systems do not instantly produce high purity water as soon as they are turned on. There is a period of time after turn-on when water of purity less than desired is produced and this start-up water has to be diverted to drain or possible re-cycled to the feed side of the RO system until the RO system reaches steady state rejection. When RO feeds a CEDI system, it is also necessary to divert start-up water to prolong the functional life of the CEDI module. Standard usage is to have a storage tank after the CEDI system to supply users with water on demand. As the water in the tank sits it tends to deteriorate as described above. Furthermore, if demand high, the tank will fall below its set point, usually controlled by a depth sensor and associated control system, and the RO and piping etc. behind the CEDI will have to be flushed before refill starts, delaying use.

The effect of water storage on high purity water was investigated by Gabler et al in an article published in the Journal of Liquid Chromatography & Related Technologies, Volume 6, Issue 13 Nov. 1983, pages 2565-2570. This research found that that increasing storage time degraded the quality of high purity water. Organics could be detected in initially high purity water after as little as one hour in storage in plastic containers. Organics could also be detected for water stored in glass.

An embodiment of the present invention allows the user to have instant access to high purity water by placing the storage tank after the pretreatment and RO systems and ahead of the CEDI system. The “partially purified” water can be run through the CEDI system immediately while the RO system is run to drain or recycle. Once the RO system is at steady state, product water is sent to the storage tank for as long as needed.

The storage tank may be a gas pressurized or a pressurized bladder type, or a standard tank with a pump on the outlet to feed the CEDI system. The tank may have a inert gas (e.g., nitrogen) input to reduce carbon dioxide absorption. Other water purification modules may be located between the RO system and the tank, for example, hydrophobic membrane degassers, or ultraviolet light TOC removal devices, or mixed bed ion exchange beds.

### BRIEF DESCRIPTION OF THE DRAWINGS

FIG. 1 depicts a system for on-demand intermittent high purity water production in accordance with the present invention.

### SUMMARY OF THE INVENTION

The current invention is directed to an on-demand system for intermittent high purity water production which by locating a storage tank for pre-polished water just prior to a final high purity polishing device reduces the potential for stagnant water in the system to reduce or degrade product high purity water quality and the actual reduction of high purity water quality.

In an embodiment, the pre-polished water is produced by at least one reverse osmosis membrane module. In an embodiment, final polishing is done by continuous electrodeionization.

### DETAILED DESCRIPTION OF THE INVENTION

The system described herein allows a user of an intermittent high purity water producing apparatus to obtain fresh high purity water on demand. By fresh is meant that the water is produced at approximately the time of demand. The system comprises a reverse osmosis membrane component fluidly connected to a storage tank to hold RO treated water. The storage tank is fluidly connected to a continuous electrodeionization component. Depending on the feed water characteristics and the users' needs, other components may be used to pretreat the RO feed water, or to further treat the RO permeate before or during storage.

Fluidly connected refers to the liquid of a process step or piece of equipment being transferred to another step or piece of equipment. This can be accomplished by piping and any associated valves and control equipment, or could be done in a semi-batch mode where the fluid is held in a tank or other storage after a process step until pumped or otherwise transported to a next process step or piece of equipment.

Intermittently produced high purity water is widely used in laboratories and small processes where such water is only needed for a task. For example, high purity water is used in laboratory dishwashers to obtain trace contaminate free glassware. These dishwashers are generally used when filled, which could be once or several times a day. When not required the water purification system is idle, which for weekends and holidays, could be more than 24 hours. Similarly, high purity water supplied to autoclaves and environmental chambers will in many cases require intermittent operation. In life science and analytical laboratories, various quantities of high purity water are needed to supply researchers with trace contaminate free water for reactions and analyses in volumes of a few milliliters to a few liters throughout the day. Many laboratories operate on a single shift, which means that the water system is idle more than it is operated.

On-demand high purity water refers to having high purity water substantially instantaneously available for use when the high quality process is turned on or the supply valve opened.

The location of the storage tank is an important aspect of the system. By locating the tank after the RO and ahead of the CEDI, a source of water that is almost purified is readily available to be polished by the CEDI on demand. Any quality deterioration of the water in the storage tank is removable by the CEDI, and since the water is RO treated, the amount of water quality change will be within the capability of the CEDI to purify without greatly affecting the CEDI equipment. Water stored after the CEDI which deteriorates in quality will of course directly affect whatever operation where it is used. Stored water and other water remaining in the system piping or equipment when water is not being processed is stagnant water, which is prone to deteriorating from, for example, microbiological growth or leaching ions, metals or organic components from piping or equipment surfaces contacting the stagnant water.

Reverse osmosis membrane modules can be supplied in a variety of properties. So-called seawater membranes are used to desalinate seawater (equivalent to approximately 35,000 ppm NaCl) at pressure of 800-1500 psi. This type of membrane will retain over 99% of incident salt. While it is possible that seawater membranes may be used, brackish water membranes are commonly used in the intermittent systems described and operate at lower pressures in waters of lower ionic strength. The feed water generally is municipal water. Brackish water membranes have relatively lower inherent retention of salt ions, but have a higher permeability. Nanofiltration (NF) membranes are so-called “loose” reverse osmosis membranes which retain multivalent ions and species of greater than about 400 molecular weight. NF generally pass a high percentage of monovalent ions. They have relatively higher permeability than the brackish water membranes.

In a RO process, a flow of feed water contacts across one side of the RO membrane at an elevated pressure. The pressure is above the osmotic pressure of the feed water, generally multiples of the osmotic pressure. Purified water passes through the membrane to the low pressure side of the process as permeate. The retained salts and organic matter removed from the feed water are concentrated in the remaining water, that is, the water that does not exit as permeate. This is the reject stream, which is piped or directed to be processed or otherwise disposed of. Organic matter removal is referred to as TOC (total oxidizable carbon) removal, relating to the analytical method used to measure organic matter in water.

In the present system, RO produces partially purified water or pre-polished water, the RO permeate, which is stored just prior to the final polishing step or apparatus.

The RO feed water usually undergoes a pretreatment step to protect the RO system by removing particles, organic matter, bacteria, and other contaminants. Prefiltration is a preferred method. Slow sand filtration may be used. A more preferred method is dual media sand filtration. This method uses a layer of anthracite over a layer of fine sand. Other methods may be used singularly or in combination. These include, but are not limited to, mixed media filtration and non-woven fabric or other cartridge filtration. A highly preferred method for the final polishing is continuous electrodeionization (CEDI).

Electrodialysis desalinates water by transferring ions and some charged organics through ion-selective membranes under the motive force of a direct current voltage. An ED apparatus consists of anion transfer membrane and cation transfer membranes arranged in cells. Each cell is bounded by an anion and a cation transfer membrane and combined into cell pairs, i.e., two adjacent cells. The membranes are electrically conductive and water impermeable. Membrane stacks consist of many, sometime hundreds of cell pairs, and an ED systems consists of many stacks. Each membrane stack has a DC electrode at each end of the stack, a cathode and an anode. Under a DC voltage, ions move to the electrode of opposite charge. There are two types of cells, diluting cells and concentrating cells. In a diluting cell, cations will pass through the cation transfer membrane facing the anode, but be stopped by the paired membrane of the adjacent cell in that direction which is an anion transfer membrane in the adjacent cell facing the cathode. Similarly, anions pass through the anion transfer membrane facing the cathode, but will be stopped by the cation transfer membrane facing the anode. In this manner, the salt in diluting cell will be removed and in the concentrating adjacent cells cations will be entering from one direction and anions from the opposite direction. Flow in the stack is arranged so that the dilute and concentrated flows are kept separate, and in this manner, a desalinated water stream is produced.

In the ED process, material commonly builds up at the membrane surface in the direction of the electric field, which can, and usually does reduce process efficiency. To combat this effect, electrodialysis reversal (EDR) was developed and is the primary method of use presently. In EDR, the electrodes are reversed in polarity on a regular basis, for example, every fifteen minutes. The flows are simultaneously switched as well, the concentrate becoming the dilute flow and vice versa. In this way fouling deposits are removed and flushed out.

Once the concentration in the dilution cells falls to lower than about 200 milligrams/liter (mg/l), electrical resistance is at a level that power demand becomes increasing expensive. To overcome this, and to be able to produce high quality water, electrodeionization (EDI), sometimes called continuous electrodeionization (CEDI) was developed. In this method the cells are filled with ion exchange media, usually ion exchange beads. The ion exchange media is orders of magnitude more conductive than the solution. The ions are transported by the beads to the membrane surface for transfer to the concentration cells. EDI is capable of producing purer water then ED at less power when the feed concentration is reduced sufficiently.

The intermediate storage tank can be conveniently sized depending on the use. If the CEDI component has a operating flow rate of X ml/minute, and the RO system requires Y ml of flush volume to reach steady state at a operating RO permeation rate of Z ml/minute, the Z(Y/X) is the minimum volume needed for the tank. A skilled practitioner will design the tank at some multiple of the minimum as a safety factor, for example 1.5 to 3 times the minimum.

The tank may be constructed of stainless steel or other metal, but in many cases trace metal ions would be damaging to the analyses or reactions. Therefore, plastic tanks are preferred. Tanks made from polyethylene, polyvinylfluoride or polytetrafloroethylene are examples of suitable materials. In some cases glass or glass lined tanks may be used. A preferred tank construction is fiberglass reinforced plastic tank with a plastic liner.

A pressurized tank requires no intermediate pump and can supply product water on demand. Also, by using inert gas or other purified gas to maintain pressure, carbon dioxide absorption is reduced or eliminated. A pressurized bladder type pressure maintaining system is a preferred type as no contact with the pressurizing fluid occurs.

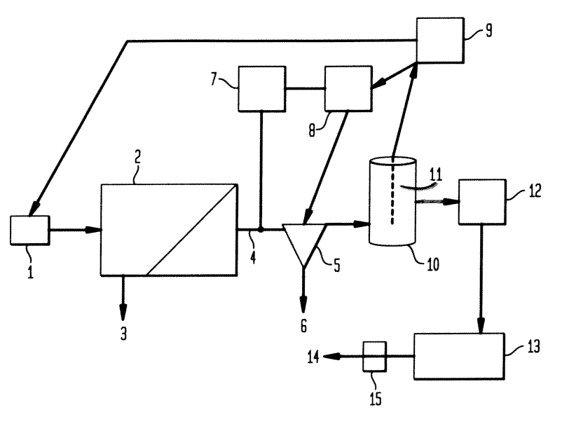

FIG. 1 illustrates a system in accordance with the present invention. Feed water, usually filtered, is supplied by a feed pump (1) to the RO module (2) at a suitable pressure. The water stream is separated into a permeate stream (4) depleted of ions and impurities and a reject or concentrate stream (3) containing the removed materials. When high purity water is demanded from the CEDI, the RO feed pump starts and the RO permeate is diverted to drain (6) or may be recycled to an RO feedstream. Permeate diversion may be done by a three way valve (5) which diverts the permeate stream until the quality of the permeate is within desired range. This can be done by diverting for a time previously determined by experimentation. Alternatively, it may be controlled by measuring the permeate conductivity with a conductivity sensor (7) and changing flow direction once the desired conductivity of the steady state rejection is reached. This can be done manually, but is more preferably done by a feedback controller (8) that receives a signal from the conductivity sensor and switches flow from the diversion flow to flow into the storage tank (10).

The tank may have a controller (9) connected to a depth sensor (11) which will signal the feed pump to shut off and close the permeate stream of valve (5) once the set point depth is reached. If the storage tank is a pressurized tank, (12) is a valve that opens on demand. If the storage tank is unpressurized, item (12) represents a pump and optional valve which open and start upon demand initiation. Upon demand initiation, flow from the storage tank enters the CEDI module (13) and product water is produced and supplied (14). Valve 15 is connected to the electrical controller that starts the high purity water production process so that when a user opens the valve, the overall system starts producing high purity water to make up for withdrawal.

For a system using a pressurized tank, sensor (11) may incorporate a pressure sensor or transducer connected to controller (9) to similarly shut off flow when set-point pressure is reached.

A practitioner may run the initial RO flush at a higher pressure than operating pressure to reduce the time to reach steady state. Also, the diverted permeate may be returned to dilute the feed stream which may reduce start-up time.

Practitioners skilled in the art will recognize that high purity water production will vary depending on site conditions. Each location will have its own combination of feed—types and concentrations of salts, organic solutes, and foulants—and ambient conditions. Also, each industry using the novel system described herein will have their particular definition of high purity water. The descriptions given herein are meant to be representative, and are not to be limiting in any way, but to be used plan and implement the novel system, modified for the conditions and requirements of a specific case.

What is claimed is:

1. An on-demand system for intermittent high purity water production, said water having the potential for stagnant water quality deterioration reduced by locating a storage tank for pre-polished water just prior to a final high purity polishing device.

2. The system of claim 1 wherein the pre-polished water is produced by a pressurized water treatment system comprising at least one reverse osmosis module.

3. The system of claim 2 wherein the reverse osmosis system produces water having feed water ionic content reduced by at least 90 percent.

4. The system of claim 2 wherein the reverse osmosis system produces water having feed water TOC reduced by at least 90 percent.

5. The system of claim 1 wherein the polishing device comprises at least one continuous electrodeionization module.

6. The system of claim 1 wherein the storage tank is a pressurized tank.

7. The system of claim 1 wherein the pre-polished water is produced by a pressurized water treatment system comprising at least one reverse osmosis module and the polishing device comprises at least one continuous electrodeionization module.

8. The system of claim 7 wherein the storage tank is a pressurized tank

9. An on-demand system for intermittent high purity water production having reduced stagnant water quality deterioration effected by locating a storage tank for pre-polished water just prior to a final high purity polishing device.

10. The system of claim 9 wherein the pre-polished water is produced by a pressurized water treatment system comprising at least one reverse osmosis module.

11. The system of claim 10 wherein the reverse osmosis system produces water having feed water ionic content reduced by at least 90 percent.

12. The system of claim 10 wherein the reverse osmosis system produces water having feed water TOC reduced by at least 90 percent.

13. The system of claim 9 wherein the polishing device comprises at least one continuous electrodeionization module.

14. The system of claim 9 wherein the storage tank is a pressurized tank.

15. The system of claim 9 wherein the pre-polished water is produced by a pressurized water treatment system comprising at least one reverse osmosis module and the polishing device comprises at least one continuous electrodeionization module.

16. The system of claim 15 wherein the storage tank is a pressurized tank

17. A system for intermittent supply of high purity water that provides high purity water on demand, wherein said system comprises, in sequence:
a water treatment component;
a storage tank fluidly connected to said water treatment component; and
a continuous electrodeionization component fluidly connected to said storage tank.

18. The system of claim 17 wherein the water treatment comprises a pressurized water treatment system having at least one reverse osmosis membrane module.

19. The system of claim 17 wherein the storage tank is a pressurized tank.
